(19) United States
(12) Patent Application Publication
(10) Pub. No.: US 2024/0195079 A1
(43) Pub. Date: Jun. 13, 2024

(54) ANTENNA DEVICE, ANTENNA MODULE, AND COMMUNICATION DEVICE

(71) Applicant: Murata Manufacturing Co., Ltd., Nagaokakyo-shi (JP)

(72) Inventor: Ryo KOMURA, Nagaokakyo-shi (JP)

(73) Assignee: Murata Manufacturing Co., Ltd., Nagaokakyo-shi (JP)

(21) Appl. No.: 18/588,270

(22) Filed: Feb. 27, 2024

Related U.S. Application Data
(63) Continuation of application No. PCT/JP2022/032031, filed on Aug. 25, 2022.

(30) Foreign Application Priority Data
Sep. 3, 2021 (JP) 2021-143840

(51) Int. Cl. H01Q 21/06; H01Q 1/48

(52) U.S. Cl. CPC H01Q 21/06; H01Q 1/48

(57) ABSTRACT

An antenna device includes a ground substrate including a ground electrode, and a plurality of separate substrates that are mounted on the ground substrate. Each of the plurality of separate substrates includes a dielectric substrate, and a plurality of antenna elements each of which radiates a radio wave whose polarization direction is an X-axis direction and a radio wave whose polarization direction is a Y-axis direction. The plurality of antenna elements are arranged along the X-axis direction and the Y-axis direction on the dielectric substrate on each of the plurality of separate substrates.

### CROSS-REFERENCE TO RELATED APPLICATIONS

This application is a continuation of international application no. PCT/JP2022/032031, filed Aug. 25, 2022, which claims priority to Japanese application no. 2021-143840, filed Sep. 3, 2021. The entire contents of both prior applications are hereby incorporated by reference.

### TECHNICAL FIELD

The present disclosure relates to an antenna device in which a plurality of second substrates, each of which has a plurality of antenna elements, are mounted on a first substrate, in which a ground is formed, and relates to an antenna module and a communication device that include the antenna device.

### BACKGROUND ART

A conventional array antenna may include a plurality of antenna elements. In this array antenna, a plurality of separate substrates (second substrates) that include dielectric are mounted on one substrate (first substrate). On each of the plurality of separate substrates, a single piece of antenna element is arranged.

### CITATION LIST

### Patent Document

Patent Document 1: U.S. Patent Application Publication No. 2021/0091017

### SUMMARY

### Technical Problem

In array antennas, it is generally desirable to set the distance between adjacent antenna elements to less than a predetermined value (a value smaller than a wavelength of a radiated radio wave). Therefore, when a single piece of antenna element is arranged on each of a plurality of separate substrates, the size of each separate substrate is considerably limited to avoid interference between adjacent separate substrates. Accordingly, it may be impossible to secure a sufficient area of the separate substrate (dielectric substrate) for each antenna element and a frequency bandwidth in which return loss is favorable may be consequently narrowed.

The present disclosure has been made to solve the above problems, and, for example, the present disclosure widens the frequency bandwidth in which a return loss is favorable, in an antenna device in which a plurality of second substrates, each of which has antenna elements, are mounted on a first substrate on which a ground is formed.

### Solution to Problem

An antenna device according to the present disclosure includes a first substrate including a ground, and a plurality of second substrates that are mounted on the first substrate. Each of the plurality of second substrates includes a dielectric substrate, and a plurality of antenna elements each of which is configured to radiate a radio wave whose polarization direction is a first direction. The plurality of antenna elements are arranged along the first direction on the dielectric substrate.

### Advantageous Effects

According to the present disclosure, not a single piece but a plurality of antenna elements are arranged on each of a plurality of separate substrates. The plurality of antenna elements are arranged along the first direction (polarization direction) on the dielectric substrate. This configuration can secure a wider area of the dielectric substrate in the first direction (polarization direction) with respect to each of the plurality of antenna elements, compared to the configuration in which a single piece of antenna element is arranged on each of a plurality of separate substrates. As a result, it is possible to widen the frequency bandwidth in which a return loss is favorable, in the antenna device in which a plurality of second substrates, each of which has antenna elements, are mounted on the first substrate on which a ground is formed.

### BRIEF DESCRIPTION OF DRAWINGS

FIG. 1 is an example of a block diagram of a communication device to which an antenna device is applied.

FIG. 2 is a diagram illustrating frequency characteristics of a return loss in a configuration in which one piece of antenna element is arranged on one piece of separate substrate.

FIG. 3 is a diagram (I) illustrating an example of a configuration of an antenna device.

FIG. 4 is a perspective view of the antenna device.

FIG. 5 is a V-V sectional view of the antenna device of FIG. 4.

FIG. 6 is a diagram schematically illustrating lines of electric force generated between antenna elements and a ground electrode.

FIG. 7 is a diagram (I) for explaining antenna characteristics of the antenna device.

FIG. 8 is a diagram (II) illustrating an example of a configuration of an antenna device.

FIG. 9 is a diagram (I) illustrating arrangement examples of antenna elements.

FIG. 10 is a diagram (II) illustrating arrangement examples of antenna elements.

FIG. 11 is a diagram (II) for explaining antenna characteristics of an antenna device.

FIG. 12 is a diagram (III) illustrating an example of a configuration of an antenna device.

FIG. 13 is a diagram (IV) illustrating an example of a configuration of an antenna device.

FIG. 14 is a diagram (V) illustrating an example of a configuration of an antenna device.

FIG. 15 is a diagram (VI) illustrating an example of a configuration of an antenna device.

### DETAILED DESCRIPTION

An exemplary embodiment according to the present disclosure will be described in detail below with reference to the accompanying drawings. Here, the same reference characters are given to the same or corresponding portions and the description thereof will not be repeated.

### (Basic Configuration of Communication Device)

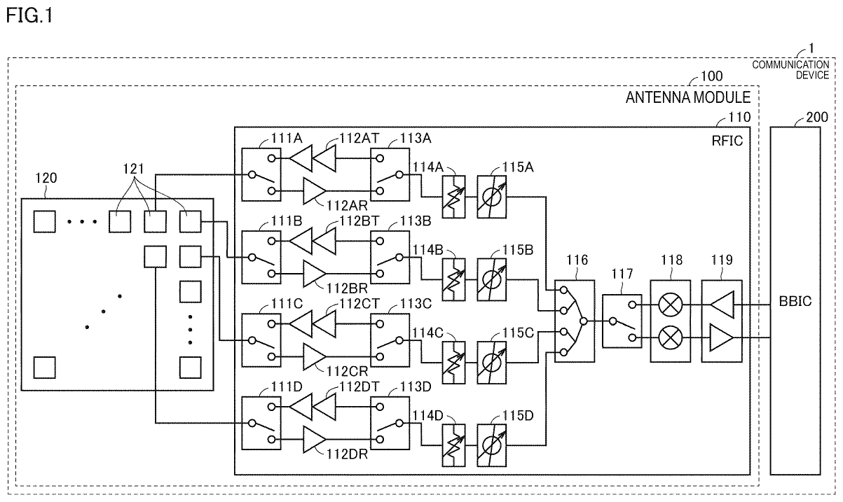

FIG. 1 is an example of a block diagram of a communication device 1 to which an antenna device 120 according to the present exemplary embodiment is applied. The communication device 1 is, for example, a portable terminal such as a cellular phone, a smartphone, and a tablet, or a personal computer with a communication function.

Referring to FIG. 1, the communication device 1 includes an antenna module 100 and a BBIC 200, which constitutes a baseband signal processing circuit. The antenna module 100 includes an RFIC 110, which is an example of a feed circuit, and the antenna device 120. The communication device 1 up-converts a signal, which is transmitted from the BBIC 200 to the antenna module 100, to a radio frequency signal and radiates the radio frequency signal from the antenna device 120. Further, the communication device 1 down-converts a radio frequency signal, which is received at the antenna device 120, and processes the obtained signal at the BBIC 200.

The antenna device 120 includes a plurality of antenna elements 121. In the present exemplary embodiment, the antenna element 121 is a patch antenna having a substantially-square flat-plate shape.

The RFIC 110 is connected between the antenna device 120 and the BBIC 200. FIG. 1 only illustrates the configuration corresponding to four pieces of antenna elements 121 and omits the illustration of the same configurations corresponding to other antenna elements 121 in the configuration of the RFIC 110, for the sake of simpler description.

The antenna device 120 according to the present exemplary embodiment is a so-called dual polarization type array antenna that can radiate two radio waves, which have mutually-different polarization directions, from each antenna element 121, as described later. Therefore, each antenna element 121 is supplied with a radio frequency signal for first polarization and a radio frequency signal for second polarization from the RFIC 110. Here, FIG. 1 only illustrates the configuration corresponding to the radio frequency signal for the first polarization and omits the illustration of the same configuration corresponding to the radio frequency signal for the second polarization in the configuration of the RFIC 110, for the sake of simpler description.

The RFIC 110 includes switches 111A to 111D, 113A to 113D, and 117; power amplifiers 112AT to 112DT; low noise amplifiers 112AR to 112DR; attenuators 114A to 114D; phase shifters 115A to 115D; a signal synthesizer/demultiplexer 116; a mixer 118; and an amplifying circuit 119.

In transmitting a radio frequency signal, the switches 111A to 111D and 113A to 113D are switched to the power amplifiers 112AT to 112DT sides and the switch 117 is connected to a transmission amplifier of the amplifying circuit 119. In receiving a radio frequency signal, the switches 111A to 111D and 113A to 113D are switched to the low noise amplifiers 112AR to 112DR sides and the switch 117 is connected to a reception amplifier of the amplifying circuit 119.

A signal transmitted from the BBIC 200 is amplified in the amplifying circuit 119 and up-converted in the mixer 118. A transmission signal that is the up-converted radio frequency signal is demultiplexed into four signals in the signal synthesizer/demultiplexer 116 and fed to respective mutually-different antenna elements 121 through four respective signal paths. At this time, the directivity of the antenna device 120 can be adjusted by individually adjusting phase levels of the phase shifters 115A to 115D arranged on respective signal paths.

Reception signals which are radio frequency signals received by respective antenna elements 121 pass through four respective different signal paths and synthesized in the signal synthesizer/demultiplexer 116. The synthesized reception signal is down-converted in the mixer 118 and amplified in the amplifying circuit 119 to be transmitted to the BBIC 200.

The RFIC 110 is formed as one chip of integrated circuit component having the above-described circuit configuration, for example. Alternatively, devices (switch, power amplifier, low noise amplifier, attenuator, phase shifter) corresponding to each antenna element 121 in the RFIC 110 may be formed as one chip of integrated circuit component for each corresponding antenna element 121.

### (Configuration of Antenna Device)

In the antenna device 120 according to the present exemplary embodiment, a plurality of separate substrates are mounted on a ground substrate, in which a ground is formed, and the antenna elements 121 are arranged on each of the separate substrates. The ground and the antenna element are thus arranged on respective different substrates, which increases design flexibility compared to the configuration in which a ground and an antenna element are arranged on the same substrate. This makes it easier to take measures such as reducing the cost of substrate materials by limiting portions where relatively expensive high dielectric materials are used, for example.

If a single piece of antenna element is arranged on a single piece of separate substrate in the configuration in which antenna elements are arranged on separate substrates as described above, a frequency bandwidth in which a return loss is favorable may be narrowed.

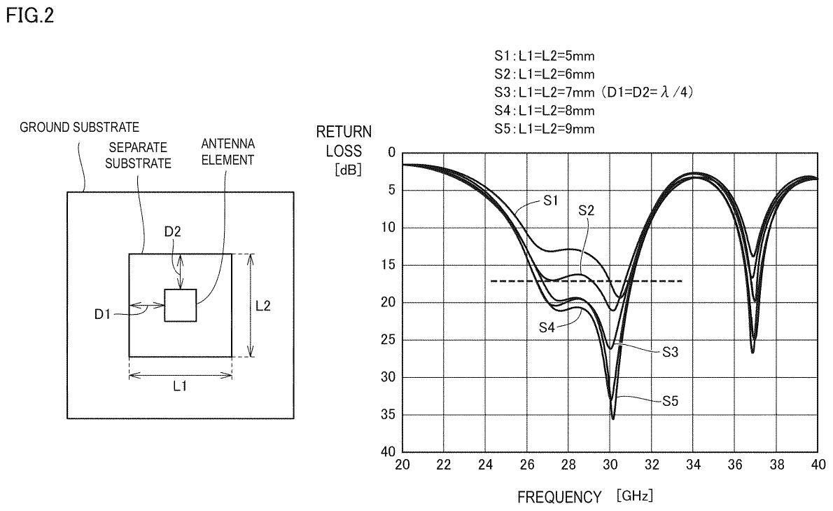

FIG. 2 is a diagram illustrating frequency characteristics of a return loss in a configuration in which one piece of antenna element is arranged on one piece of separate substrate. In FIG. 2, the horizontal axis represents frequency (GHz) and the vertical axis represents a return loss as attenuation.

Here, a return loss is a ratio of reflected power with respect to power inputted into an antenna device, expressed in decibels (dB). Regarding total reflection (100% reflectance), the value of return loss is 0 dB, and the value of return loss increases as reflection is smaller. In other words, a higher value of return loss means that a power loss due to reflection itself is smaller and the return loss is better.

FIG. 2 illustrates reflection characteristics S1 to S5 obtained by changing the length of one side (=L1=L2) of a separate substrate that has a square shape and includes an antenna element arranged on the center thereof. The reflection characteristics S1 are characteristics obtained when the length of one side of the separate substrate is set to 5 mm. The reflection characteristics S2 are characteristics obtained when the length of one side of the separate substrate is set to 6 mm. The reflection characteristics S3 are characteristics obtained when the length of one side of the separate substrate is set to 7 mm. The reflection characteristics S4 are characteristics obtained when the length of one side of the separate substrate is set to 8 mm. The reflection characteristics S5 are characteristics obtained when the length of one side of the separate substrate is set to 9 mm.

In FIG. 2, when the length of one side of the separate substrate is 7 mm, the shortest distance (=D1=D2) between the antenna element and end surfaces of the separate substrate is approximately λ/4. Here, “λ” denotes wavelength of a radio wave, which is radiated by the antenna element, in free space.

As can be seen from FIG. 2, as the length of one side of the separate substrate is increased, the return loss increases. For example, when a reference value of the return loss is set to 17 dB, a frequency range in which the return loss is higher than or equal to the reference value (frequency bandwidth in which the return loss is favorable) is widened as the length of one side of the separate substrate is increased.

However, in array antennas, it is generally desirable to set the distance between adjacent antenna elements to less than λ (for example, λ/2). Accordingly, if the length of one side of a separate substrate is increased, adjacent separate substrates are abutted on each other, being unable to sufficiently increase the length of one side of the separate substrates. That is, in the configuration in which a single piece of antenna element is arranged on each of a plurality of separate substrates, it may be impossible to secure a sufficient area of the separate substrate (dielectric substrate) for each antenna element and the frequency bandwidth in which return loss is favorable may be consequently narrowed.

In the present exemplary embodiment, not a single piece but a plurality of antenna elements are arranged on each of a plurality of separate substrates.

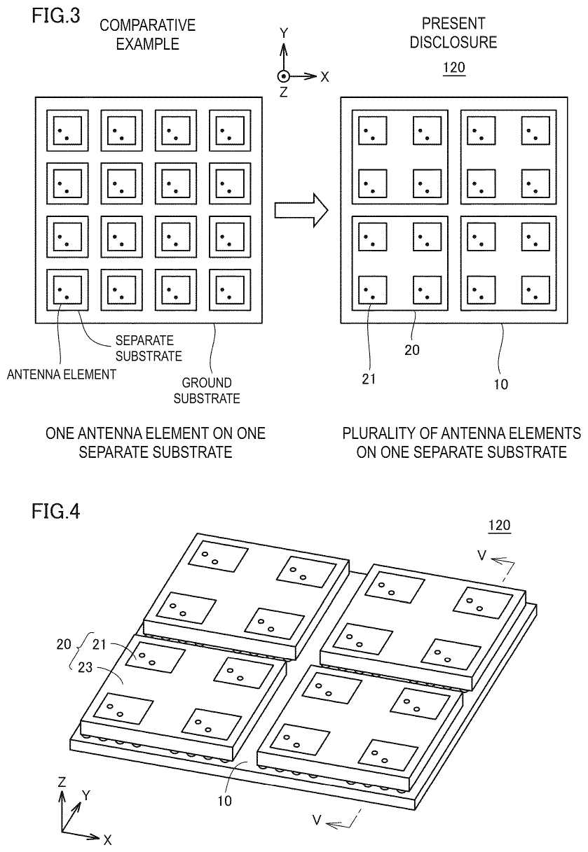

FIG. 3 is a diagram illustrating an example of a configuration of the antenna device 120 according to the present exemplary embodiment. The left side of FIG. 3 illustrates a configuration of an antenna device in which 16 pieces of separate substrates are arrayed in a 4×4 two-dimensional pattern on a ground substrate and a single piece of antenna element is arranged on each of the separate substrates, as a comparative example corresponding to the antenna device 120 according to the present exemplary embodiment.

The right side of FIG. 3 illustrates an example in which four pieces of separate substrates 20 are arranged on a main surface of a ground substrate 10 and four pieces of antenna elements 21 are arranged on each of the four pieces of separate substrates 20, as an example of the configuration of the antenna device 120 according to the present exemplary embodiment.

In the following description, a normal direction of the main surface of the ground substrate 10 may be referred to as a “Z-axis direction”, and respective directions that are orthogonal to the Z-axis direction and are orthogonal to each other may be referred to as an “X-axis direction” and a “Y-axis direction”. Further, the description may be provided on the assumption that a positive direction of the Z axis in each drawing is an upper surface side and a negative direction of the same is a lower surface side, hereinafter.

Each of the antenna elements 21 is a dual polarization type antenna element that can radiate a radio wave whose polarization direction is the X-axis direction and a radio wave whose polarization direction is the Y-axis direction. Here, the antenna elements 21 illustrated in FIG. 3 correspond to the antenna elements 121 illustrated in FIG. 1.

As illustrated in FIG. 3, in the antenna device 120 according to the present exemplary embodiment, four pieces of separate substrates 20 are arranged two by two along the X-axis direction and the Y-axis direction on the main surface of the ground substrate 10. On each of the four pieces of separate substrates 20, four pieces of antenna elements 21 are arranged two by two along the X-axis direction and the Y-axis direction.

That is, in the antenna device 120 according to the present exemplary embodiment, a plurality of antenna elements 21 are arranged along the polarization directions (the X-axis direction and the Y-axis direction) on each of the plurality of separate substrates 20. Accordingly, the size of each separate substrate can be increased compared to the comparative example in which a single piece of antenna element is arranged on each of a plurality of separate substrates. This can secure a wide area of the separate substrate 20 (dielectric substrate) in the polarization directions with respect to each of the plurality of antenna elements 21. As a result, the frequency bandwidth in which the return loss is favorable can be widened.

FIG. 4 is a perspective view of the antenna device 120 according to the present exemplary embodiment. The configuration of the antenna device 120 according to the present exemplary embodiment will be described in more detail with reference to FIG. 4.

The antenna device 120 includes the ground substrate 10 and four pieces of separate substrates 20. The four pieces of separate substrates 20 are arranged on the upper surface of the ground substrate 10, two by two along the X-axis direction and the Y-axis direction spaced at a predetermined interval.

Each of the separate substrates 20 includes four pieces of antenna elements 21 and a dielectric substrate 23. The dielectric substrate 23 is formed in a substantially square shape in plan view in the Z-axis direction. The four pieces of antenna elements 21 are arranged on the dielectric substrate 23, two by two along the X-axis direction and the Y-axis direction.

The antenna device 120 according to the present exemplary embodiment thus mounts the 4 pieces of separate substrates 20, each of which includes 4 pieces of antenna elements 21, on the ground substrate 10, being an array antenna in which total 16 pieces of antenna elements 21 are arrayed. Here, each distance between adjacent antenna elements (distance between face centers (intersections of diagonals) of adjacent antenna elements 21) is set to approximately λ/2.

FIG. 5 is a V-V sectional view of the antenna device 120 of FIG. 4. Here, FIG. 5 omits illustration of part of the cross-sectional profile.

The ground substrate 10 includes a dielectric 11 and a ground electrode GND, which is arranged in an inner layer of the dielectric 11. The ground electrode GND has a flat-plate shape expanding in the Y-axis direction and the X-axis direction.

The dielectric substrate 23 of the separate substrate 20 has an upper surface 23a and a lower surface 23b, which is opposed to the upper surface 23a. On the upper surface 23a of the dielectric substrate 23, two antenna elements 21 are arranged along the Y-axis direction at a predetermined interval.

On the lower surface 23b of the dielectric substrate 23, mounting terminal portions 24 are arranged. The mounting terminal portions 24 are used for mounting the dielectric substrate 23 on an upper surface (main surface) 10a of the ground substrate 10. The mounting terminal portions 24 are made of conductor such as a plurality of solder bumps.

Thus, in the antenna device 120 according to the present exemplary embodiment, the number of antenna elements 21, which are arranged along the Y-axis direction of one piece of separate substrate 20, is set to not one but two (a plurality of pieces). Accordingly, the size of each of the separate substrates 20 in the Y-axis direction can be increased compared to the configuration in which a single piece of antenna element 21 is arranged in the Y-axis direction on one piece of separate substrate 20. As a result, a sufficient area of the dielectric substrate 23 in the Y-axis direction (polarization direction) can be secured with respect to each of the antenna elements 21.

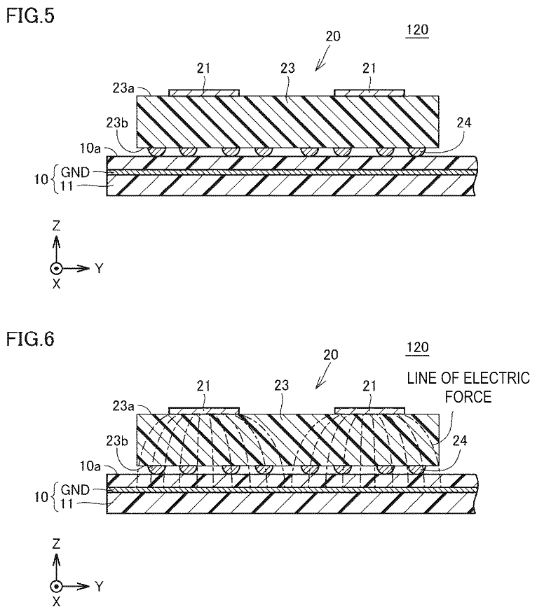

FIG. 6 is a diagram schematically illustrating lines of electric force generated between the antenna elements 21 and the ground electrode GND when each of the antenna elements 21 radiates a radio wave whose polarization direction is the Y-axis direction. In the present exemplary embodiment, a sufficient area of the dielectric substrate 23 in the Y-axis direction can be secured with respect to each of the antenna elements 21 as described above. Accordingly, the lines of electric force generated between the antenna elements 21 and the ground electrode GND can be contained inside the dielectric substrate 23, being able to form an ideal electric field state. As a result, the frequency bandwidth, in which the return loss is favorable, of the radio wave whose polarization direction is the Y-axis direction can be widened.

Further, in the antenna device 120 according to the present exemplary embodiment, two pieces (a plurality pieces) of antenna elements 21 are also arranged along the X-axis direction on one piece of separate substrate 20. This can secure a sufficient area of the dielectric substrate 23 in the X-axis direction with respect to each of the antenna elements 21. Accordingly, an ideal electric field state can be formed also when each of the antenna elements 21 radiates a radio wave whose polarization direction is the X-axis direction. As a result, the frequency bandwidth, in which the return loss is favorable, of the radio wave whose polarization direction is the X-axis direction can be widened.

In addition, in the antenna device 120 according to the present exemplary embodiment, the number of pieces of antenna elements 21 arranged along the X-axis direction and the number of pieces of antenna elements 21 arranged along the Y-axis direction are the same value (two pieces) as each other on each of the plurality of separate substrates 20. Accordingly, compared to a configuration in which the number of pieces of antenna elements 21 arranged along the X-axis direction and the number of pieces of antenna elements 21 arranged along the Y-axis direction are different from each other, each of the separate substrates 20 can be formed in more square shape, thus being able to improve symmetry of each of the separate substrates 20. As a result, each of the separate substrates 20 can be easily mounted on the ground substrate 10.

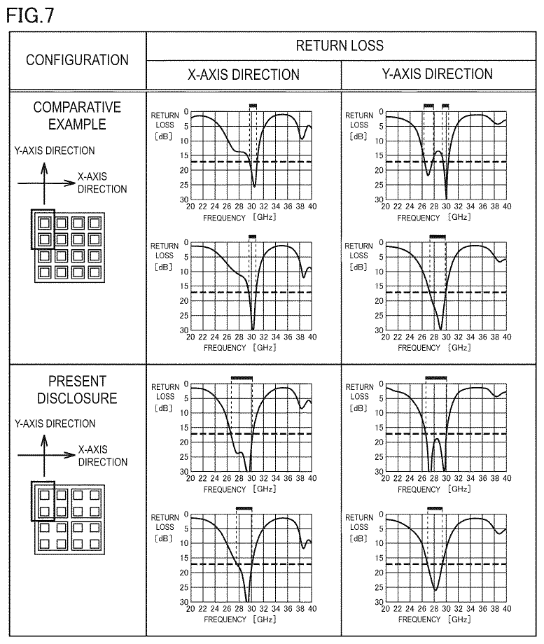

FIG. 7 is a diagram for explaining antenna characteristics of the antenna device 120 according to the present exemplary embodiment. The upper side of FIG. 7 illustrates characteristics of an antenna device having the configuration of the comparative example illustrated in FIG. 3 (the configuration in which a single piece of antenna element is arranged on each separate substrate). The lower side of FIG. 7 illustrates the characteristics of the antenna device 120 according to the present exemplary embodiment.

In FIG. 7, configuration of the antenna device and graphs of return loss are illustrated in order from the left side. Regarding the graphs of return loss, graphs of return loss in the X-axis direction and graphs of return loss in the Y-axis direction of two antenna elements on the upper left of each antenna device (two pieces of antenna elements framed in the configuration in FIG. 7) are illustrated.

In the antenna device of the comparative example, the frequency bandwidth in which the return loss is favorable (the frequency range in which the return loss is higher than or equal to 17 dB which is the reference value) is narrow. It is considered that this is because a single piece of antenna element is arranged on each separate substrate and accordingly a sufficient area of a separate substrate (dielectric substrate) in the polarization direction cannot be secured with respect to each antenna element.

On the other hand, in the antenna device 120 according to the present exemplary embodiment, the frequency bandwidth in which the return loss is favorable is wider than that of the comparative example. It is considered that this is because a plurality of antenna elements 21 are arranged along the polarization directions (the X-axis direction and the Y-axis direction) on each separate substrate 20 and accordingly a sufficient area of a separate substrate 20 (dielectric substrate 23) in the polarization directions can be secured with respect to each antenna element.

As described above, the antenna device 120 according to the present exemplary embodiment includes the ground substrate 10, in which the ground electrode GND is formed, and a plurality of separate substrates 20, which are mounted on the ground substrate 10. Each of the separate substrates 20 includes the dielectric substrate 23 and a plurality of antenna elements 21 each of which radiates a radio wave whose polarization direction is the X-axis direction and a radio wave whose polarization direction is the Y-axis direction. The plurality of antenna elements 21 are arranged along the X-axis direction and the Y-axis direction on the dielectric substrate 23. This configuration can secure a wider area of the dielectric substrate 23 in the polarization directions (the X-axis direction and the Y-axis direction) with respect to each of the plurality of antenna elements 21, compared to the configuration in which a single piece of antenna element 21 is arranged on each of the plurality of separate substrates 20. As a result, the frequency bandwidth in which the return loss is favorable can be widened.

Here, the “ground substrate 10”, the “separate substrate 20”, the “dielectric substrate 23”, and the “antenna element 21” in the present exemplary embodiment can correspond to a “first substrate”, a “second substrate”, a “dielectric substrate”, and an “antenna element” of the present disclosure respectively.

### [First Modification]

In the above-described exemplary embodiment, a plurality of antenna elements 21 are arranged on one piece of separate substrate 20 (the dielectric substrate 23) and each of the antenna elements 21 is accordingly arranged closer to end surfaces of the dielectric substrate 23 rather than the center of the same.

Here, lines of electric force are particularly concentrated on a region within λ/8 from end surfaces of the antenna element 21. Therefore, it is preferable that not an air layer but the dielectric substrate 23 exists in this region. In light of this point, the shortest distance between each of the plurality of antenna elements 21 and the end surfaces of the dielectric substrate 23 in the polarization directions (the X-axis direction and the Y-axis direction) may be set to λ/8 or greater on each of the plurality of separate substrates 20.

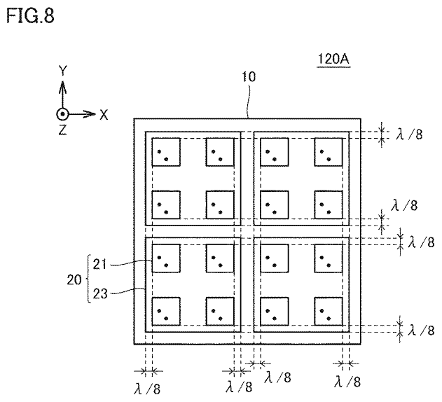

FIG. 8 is a diagram illustrating an example of a configuration of an antenna device 120A according to this first modification. As illustrated in FIG. 8, in the antenna device 120A according to this first modification, the shortest distance in the X-axis direction and the shortest distance in the Y-axis direction between each of the antenna elements 21 and the end surfaces of the dielectric substrate 23 are both set to approximately λ/8 on each of four pieces of separate substrates 20. Accordingly, not an air layer but the dielectric substrate 23 is allowed to be in the region in which lines of electric force generated between the antenna element 21 and the ground electrode GND are concentrated. As a result, an ideal electric field state can be formed and the frequency bandwidth in which the return loss is favorable can be appropriately widened.

Alternatively, the shortest distance between each of the plurality of antenna elements 21 and the end surfaces of the dielectric substrate 23 in the polarization directions may be set to λ/4 or less on each of the plurality of separate substrates 20. This can set the distance between the antenna elements 21 of two separate substrates 20, which are adjacent to each other in the polarization direction, to λ/2 or less, being able to reduce unwanted side lobes called gratings.

### [Second Modification]

In the above-described exemplary embodiment, 4 pieces of separate substrates 20 are arranged in a 2×2 two-dimensional pattern on the ground substrate 10 and 4 pieces of antenna elements 21 are arranged in a 2×2 two-dimensional pattern on each of the 4 pieces of separate substrates 20 so as to form the array antenna having total 16 pieces of antenna elements 21.

However, the total number of pieces of antenna elements 21 is not limited to 16. Further, the arrangement of the antenna elements 21 on each of the separate substrates 20 is not limited to 2×2.

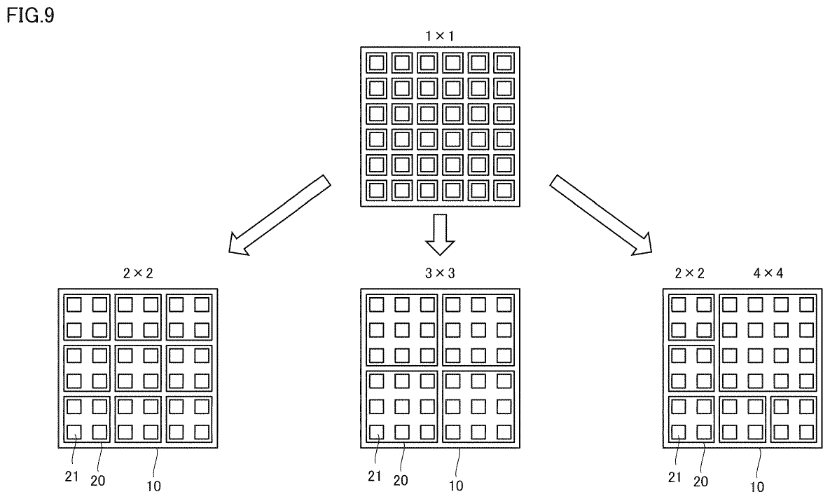

FIG. 9 is a diagram illustrating arrangement examples of the antenna elements 21 on each separate substrate 20 when the total 36 pieces of antenna elements 21 are arranged in a 6×6 two-dimensional pattern.

As illustrated on the lower left side of FIG. 9, nine pieces of separate substrates 20 may be arranged on the ground substrate 10 and four pieces of antenna elements 21 may be arranged in the 2×2 two-dimensional pattern on each of the separate substrates 20.

Alternatively, as illustrated on the lower center of FIG. 9, four pieces of separate substrates 20 may be arranged on the ground substrate 10 and nine pieces of antenna elements 21 may be arranged in a 3×3 two-dimensional pattern on each of the separate substrates 20.

Still alternatively, as illustrated on the lower right side of FIG. 9, 6 pieces of separate substrates 20 may be arranged on the ground substrate 10, 16 pieces of antenna elements 21 may be arranged in a 4×4 two-dimensional pattern on one piece of the separate substrate 20, and 4 pieces of antenna elements 21 may be arranged in the 2×2 two-dimensional pattern on the rest 5 pieces of the separate substrates 20.

In any of the arrangements, the total 36 pieces of antenna elements 21 can be arranged in the 6×6 two-dimensional pattern.

### [Third Modification]

The example in which the antenna element 21 is a dual polarization type antenna element is explained in the above-described exemplary embodiment, but the antenna element 21 may be a single polarization type antenna element.

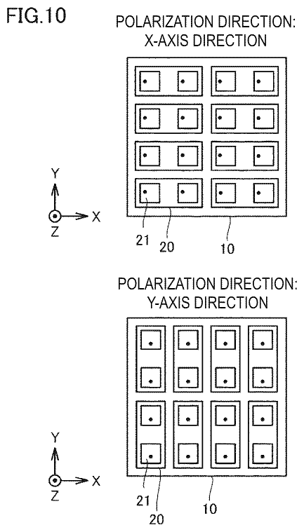

FIG. 10 is a diagram illustrating arrangement examples of the antenna elements 21 which are single polarization type antenna elements.

When the antenna element 21 radiates a radio wave whose polarization direction is the X-axis direction, a plurality of antenna elements 21 may be one-dimensionally arranged in the X-axis direction on each of the separate substrates 20, as illustrated on the upper side of FIG. 10.

Further, when the antenna element 21 radiates a radio wave whose polarization direction is the Y-axis direction, a plurality of antenna elements 21 may be one-dimensionally arranged in the Y-axis direction on each of the separate substrates 20, as illustrated on the lower side of FIG. 10.

These arrangements can secure a wide area of the dielectric substrate 23 in the polarization direction (the X-axis direction or the Y-axis direction) with respect to each of the antenna elements 21, being able to widen the frequency bandwidth in which the return loss is favorable.

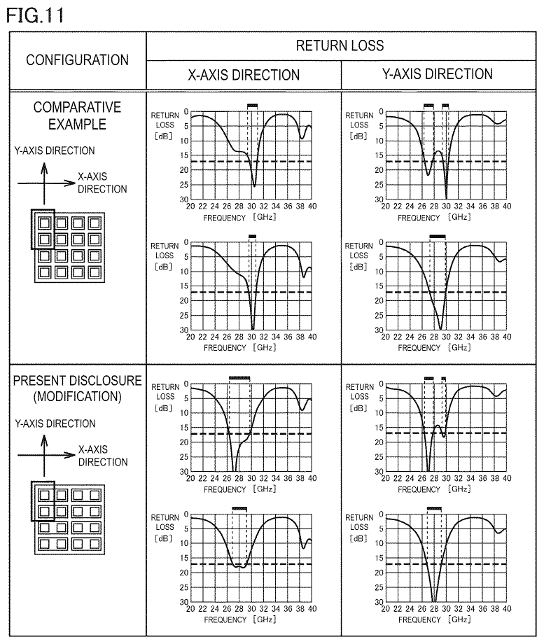

FIG. 11 is a diagram for explaining antenna characteristics of an antenna device according to this third modification. The upper side of FIG. 11 illustrates characteristics of an antenna device having the configuration of the comparative example illustrated in FIG. 3 (the configuration in which a single piece of antenna element is arranged on each separate substrate). The lower side of FIG. 11 illustrates characteristics of the configuration illustrated on the upper side of FIG. 10 (the configuration in which a plurality of antenna elements 21, each of which radiates a radio wave whose polarization direction is the X-axis direction, are arranged along the X-axis direction on each separate substrate).

As can be seen from FIG. 11, in the antenna device according to this third modification, the frequency bandwidth in which the return loss is favorable is wider than that of the comparative example. It is considered that this is because the plurality of antenna elements 21 are arranged along the polarization direction (the X-axis direction) on each separate substrate 20 and accordingly a sufficient area of a separate substrate 20 (dielectric substrate 23) in the polarization directions can be secured with respect to each antenna element 21.

When the antenna elements 21 are single polarization type antenna elements, the plurality of antenna elements 21 should be arranged along the polarization direction of a radiated radio wave on each of the separate substrates 20, as described above.

### [Fourth Modification]

The above exemplary embodiment describes the example in which four sides of each antenna element 21 are parallel or orthogonal to the directions in which the plurality of antenna elements 21 are arranged on the separate substrate 20 (the X-axis direction and the Y-axis direction in the example illustrated in FIG. 3, which may be referred to merely as “arrangement directions of a plurality of antenna elements”) in plan view of each antenna element 21 in the Z-axis direction. However, four sides of each antenna element may be inclined (intersect at an acute or obtuse angle) with respect to the arrangement directions of a plurality of antenna elements (the X-axis direction and the Y-axis direction) in plan view in the Z-axis direction.

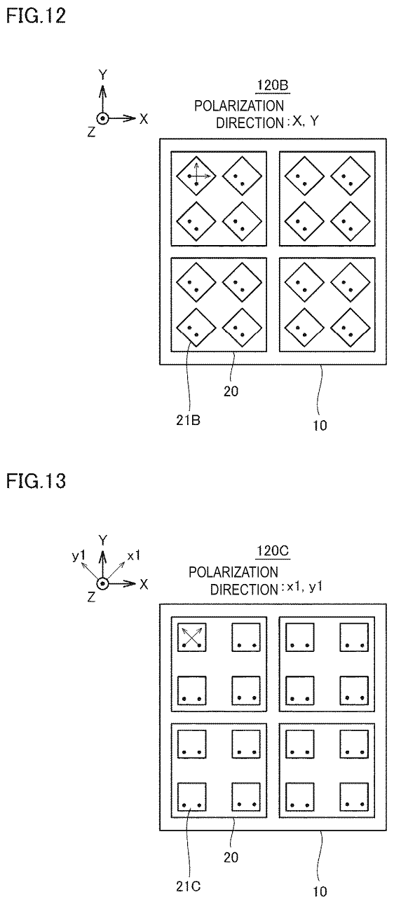

FIG. 12 is a diagram illustrating an example of a configuration of an antenna device 120B according to this fourth modification. The antenna device 120B is obtained by replacing the antenna elements 21 of the antenna device 120 according to the above-described exemplary embodiment with antenna elements 21B.

The antenna elements 21B are arranged so that four sides of each antenna element 21B are inclined at approximately 45 degrees with respect to the arrangement directions of the plurality of antenna elements 21B (the X-axis direction and the Y-axis direction) in plan view in the Z-axis direction. The polarization directions of the antenna element 21B are the same as the polarization directions of the antenna element 21 described above. Specifically, the antenna element 21B is configured to be able to radiate a radio wave whose polarization direction is the X-axis direction and a radio wave whose polarization direction is the Y-axis direction.

Thus, the plurality of antenna elements 21B, each of which has four sides inclined with respect to the X-axis direction and the Y-axis direction, may be arranged along the X-axis direction and the Y-axis direction on the separate substrate 20. This configuration can also secure a wider area of the dielectric substrate 23 in the polarization directions (the X-axis direction and the Y-axis direction) of the antenna element 21B with respect to each of the plurality of antenna elements 21B, compared to the configuration in which a single piece of antenna element 21B is arranged on each of the separate substrates 20. As a result, the frequency bandwidth in which the return loss is favorable can be widened.

### [Fifth Modification]

The above exemplary embodiment describes the example in which the polarization directions of each antenna element 21 are parallel or orthogonal to the arrangement directions of the plurality of antenna elements 21 (the X-axis direction and the Y-axis direction in the example illustrated in FIG. 3) in plan view of each antenna element 21 in the Z-axis direction. However, the polarization directions of each antenna element may be inclined (intersect at an acute or obtuse angle) with respect to the arrangement directions of a plurality of antenna elements in plan view in the Z-axis direction.

FIG. 13 is a diagram illustrating an example of a configuration of an antenna device 120C according to this fifth modification. The antenna device 120C is obtained by replacing the antenna elements 21 of the antenna device 120 according to the above-described exemplary embodiment with antenna elements 21C.

The antenna element 21C is configured to be able to radiate a radio wave whose polarization direction is a first inclination direction x1, which is inclined at approximately 45 degrees with respect to the X-axis direction, and a radio wave whose polarization direction is a second inclination direction y1, which is inclined at approximately 45 degrees with respect to the Y-axis direction. Here, the first inclination direction x1 and the second inclination direction y1 are substantially orthogonal to each other. Four sides of each antenna element 21C are arranged so as to be parallel or orthogonal to the arrangement directions of the plurality of antenna elements 21C (the X-axis direction and the Y-axis direction), as is the case with the antenna device 120.

Thus, the polarization directions (the first inclination direction x1 and the second inclination direction y1) of each antenna element 21C may be inclined (intersect at an acute or obtuse angle) with respect to the arrangement directions of the plurality of antenna elements 21C (the X-axis direction and the Y-axis direction) in plan view in the Z-axis direction. This configuration can also secure a wider area of the dielectric substrate 23 in the polarization directions (the first inclination direction x1 and the second inclination direction y1) of the antenna element 21C with respect to each of the plurality of antenna elements 21C, compared to the configuration in which a single piece of antenna element 21C is arranged on each of the separate substrates 20. As a result, the frequency bandwidth in which the return loss is favorable can be widened.

### [Sixth Modification]

The configuration obtained by combining the configuration of the above-described fourth modification and the configuration of the above-described fifth modification may be employed.

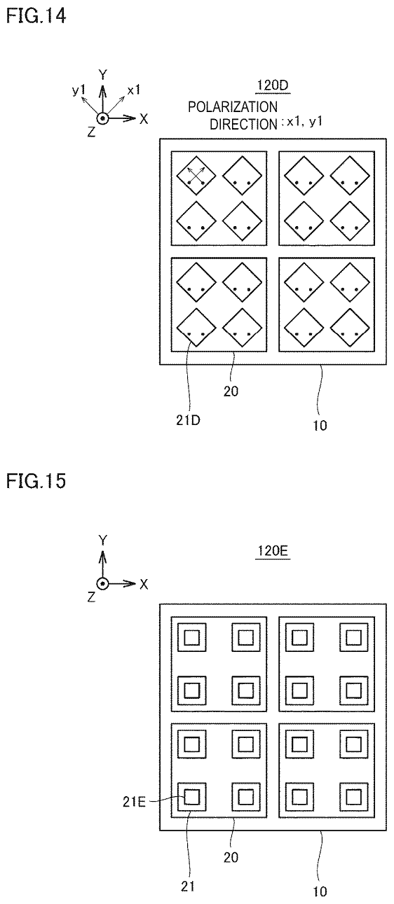

FIG. 14 is a diagram illustrating an example of a configuration of an antenna device 120D according to this sixth modification. The antenna device 120D is obtained by replacing the antenna elements 21 of the antenna device 120 according to the above-described exemplary embodiment with antenna elements 21D.

The antenna elements 21D are arranged so that four sides of each antenna element 21D are inclined at approximately 45 degrees with respect to the arrangement directions of the plurality of antenna elements 21D (the X-axis direction and the Y-axis direction) in plan view in the Z-axis direction.

Further, the antenna element 21D is configured to be able to radiate a radio wave whose polarization direction is the first inclination direction x1, which is inclined at approximately 45 degrees with respect to the X-axis direction, and a radio wave whose polarization direction is the second inclination direction y1, which is inclined at approximately 45 degrees with respect to the Y-axis direction.

Thus, the plurality of antenna elements 21D, each of which has four sides and polarization directions inclined with respect to the X-axis direction and the Y-axis direction, may be arranged along the X-axis direction and the Y-axis direction on the separate substrate 20. This configuration can also secure a wider area of the dielectric substrate 23 in the polarization directions (the first inclination direction x1 and the second inclination direction y1) of the antenna element 21D with respect to each of the plurality of antenna elements 21D, compared to the configuration in which a single piece of antenna element 21D is arranged on each of the separate substrates 20. As a result, the frequency bandwidth in which the return loss is favorable can be widened.

### [Seventh Modification]

The above-described exemplary embodiment exemplifies the antenna device 120 of a so-called single-band type. However, an antenna device to which the present disclosure is applicable is not limited to the single-band type but may be a so-called dual-band type.

FIG. 15 is a diagram illustrating an example of a configuration of an antenna device 120E according to this seventh modification. The antenna device 120E is obtained by adding a plurality of antenna elements 21E to the antenna device 120 according to the above-described exemplary embodiment.

The plurality of antenna elements 21E are arranged to correspond to the plurality of respective antenna elements 21. Each antenna element 21E is arranged at a predetermined interval in the Z-axis direction with respect to the antenna element 21 corresponding to this antenna element 21E. Each antenna element 21E is arranged at a position overlapping with the antenna element 21 corresponding to this antenna element 21E in plan view in the Z-axis direction. The size of the antenna element 21E is smaller than the size of the antenna element 21 in plan view in the Z-axis direction. The antenna element 21E is configured to be able to radiate radio waves of a higher frequency than the frequency of the radio waves radiated by the antenna element 21. The polarization directions of the antenna element 21E may be the polarization directions of the antenna element 21 (the X-axis direction and the Y-axis direction) described above or the polarization directions of the antenna element 21C (the first inclination direction x1 and the second inclination direction y1) described above.

Thus, the antenna device 120E of the so-called dual-band type may be adopted.

The exemplary embodiment disclosed here should be considered exemplary and not restrictive in all respects. The scope of the present disclosure is indicated by the scope of the claims rather than the description of the above-described exemplary embodiment, and is intended to include all changes within the scope and meaning equivalent to the scope of the claims.

### REFERENCE SIGNS LIST

1 communication device
10 ground substrate
10a, 23a upper surface
11 dielectric
20 separate substrate
21, 21B, 21C, 21D, 21E, 121 antenna element
23 dielectric substrate
23b lower surface
24 mounting terminal portion
100 antenna module
111A to 111D, 113A to 113D, 117 switch
112AR to 112DR low noise amplifier
112AT to 112DT power amplifier
114A to 114D attenuator
115A to 115D phase shifter
116 synthesizer/demultiplexer
118 mixer
119 amplifying circuit
120, 120A to 120E antenna device
GND ground electrode

1. An antenna device comprising:
a first substrate including a ground; and
a plurality of second substrates mounted on the first substrate, wherein
each of the plurality of second substrates includes
a dielectric substrate, and
a plurality of antenna elements each of which is configured to radiate a radio wave whose polarization direction is a first direction, and
the plurality of antenna elements are arranged along the first direction on the dielectric substrate on each of the plurality of second substrates.

2. The antenna device according to claim 1, wherein when a wavelength of the radio wave in free space is denoted as λ, a shortest distance between each of the plurality of antenna elements and an end surface of the dielectric substrate in the first direction is λ/8 or greater on each of the plurality of second substrates.

3. The antenna device according to claim 1, wherein a shortest distance between each of the plurality of antenna elements and an end surface of the dielectric substrate in the first direction is λ/4 or less on each of the plurality of second substrates.

4. The antenna device according to claim 3, wherein
each of the plurality of antenna elements radiates a radio wave whose polarization direction is a second direction, the second direction being different from the first direction, in addition to the radio wave whose polarization direction is the first direction, and
the plurality of antenna elements are arranged along the first direction and the second direction on the dielectric substrate on each of the plurality of second substrates.

5. The antenna device according to claim 4, wherein the shortest distance in the first direction and a shortest distance in the second direction between each of the plurality of antenna elements and the end surface of the dielectric substrate are both λ/8 or greater on each of the plurality of second substrates.

6. The antenna device according to claim 4, wherein a number of pieces of antenna elements arranged along the first direction and a number of pieces of antenna elements arranged along the second direction are the same on each of the plurality of second substrates.

7. An antenna module comprising:
the antenna device according to claim 1; and
a feed circuit that is configured to supply a radio frequency signal to the plurality of antenna elements.

8. The antenna module according to claim 7, further comprising a base band circuit configured to generate a base band signal and to provide the base band signal to the feed circuit.

9. The antenna module according to claim 8, wherein the feed circuit is configured to upconvert the base band signal received from the base band circuit to the radio frequency signal.

10. The antenna module according to claim 7, wherein the feed circuit includes at least a low noise amplifier.

11. The antenna module according to claim 7, further comprising a reception circuit configured to receive radio signals received by the plurality of antenna elements.

12. The antenna module according to claim 11, wherein the reception circuit includes a plurality of switches to switch the plurality of antenna elements from transmission to reception.

13. A communication device on which the antenna module according to claim 7 is mounted.

14. An antenna device comprising:
a first substrate including a ground; and
a plurality of second substrates mounted on the first substrate, wherein
each of the plurality of second substrates includes
a dielectric substrate, and
a plurality of antenna elements each of which is configured to radiate a radio wave whose polarization direction is a direction inclined with respect to a first direction, and
the plurality of antenna elements are arranged along the first direction on the dielectric substrate on each of the plurality of second substrates.

15. An antenna module comprising:
the antenna device according to claim 14; and
a feed circuit that is configured to supply a radio frequency signal to the plurality of antenna elements.

16. A communication device on which the antenna module according to claim 15 is mounted.

17. The antenna module according to claim 15, further comprising a base band circuit configured to generate a base band signal and to provide the base band signal to the feed circuit.

18. The antenna module according to claim 17, wherein the feed circuit is configured to upconvert the base band signal received from the base band circuit to the radio frequency signal.

19. The antenna module according to claim 15, wherein the feed circuit includes at least a low noise amplifier.

20. The antenna module according to claim 5, further comprising a reception circuit configured to receive radio signals received by the plurality of antenna elements,
wherein the reception circuit includes a plurality of switches to switch the plurality of antenna elements from transmission to reception.
